(19) United States
(12) Patent Application Publication
(10) Pub. No.: US 2013/0024269 A1
(43) Pub. Date: Jan. 24, 2013

(54) EVALUATING THIRD PARTY TARGETING DATA

(71) Applicants: Ayman Farahat, San Francisco, CA (US); Amir Cory, Palo Alto, CA (US)

(72) Inventors: Ayman Farahat, San Francisco, CA (US); Amir Cory, Palo Alto, CA (US)

(73) Assignee: Yahoo! Inc., Sunnyvale, CA (US)

(21) Appl. No.: 13/185,969

(22) Filed: Jul. 19, 2011

(51) Int. Cl. G06Q 30/00

(52) U.S. Cl. 705/14.41

(57) ABSTRACT

Determining the impact or influence of targeting data on the success of an advertisement may be useful for improving targeting and evaluating third party targeting data. Advertising may be more effective when it is properly targeted based on the audience viewing the advertisement. Identifying the audience and determining information about that audience are part of the targeting process. Audience information or targeting data may be provided by third party data providers that can be used by publishers and/or advertisers to improve targeting. Utilizing a model for assessing the value provided by targeting data may be effective when multiple variables are considered to properly attribute advertisement success to the targeting data.

### BACKGROUND

Online advertising may be an important source of revenue for enterprises engaged in electronic commerce. Processes associated with technologies such as Hypertext Markup Language (HTML) and Hypertext Transfer Protocol (HTTP) enable a web page to be configured to display advertisements. Advertisements may commonly be found on many web sites. For example, advertisements may be displayed on search web sites and may be targeted to individuals based upon search terms provided by the individuals.

As the Internet has grown, the number of web sites available for hosting advertisements has increased, as well as the diversity among web sites. In other words, the number of web sites focusing on selective groups of individuals has increased. As a result of this increase, it has become increasingly difficult for advertisers to optimize the targeting of their advertisements. Advertisers may be unfamiliar with the most effective ways to target their advertisements on websites and in sponsored searching. This may result in a lower rate of return for the advertiser. That advertiser may have received a greater rate of return had the advertiser targeted his advertisement more effectively.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 illustrates an embodiment of an evaluator;

FIG. 3 illustrates exemplary variables; and

FIG. 4 illustrates an exemplary flowchart for evaluation.

### DETAILED DESCRIPTION

By way of introduction, advertising may be more effective when it is properly targeted based on the audience viewing the advertisement. Identifying the audience and determining information about that audience are part of the targeting process. Audience information or targeting data may be provided by third party data providers that can be used by publishers and/or advertisers to improve targeting. One system for assessing the value provided by targeting data from third party data providers is described below. Although the targeting data to be evaluated is described as being from a third party, the targeting data could be local data that is evaluated.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

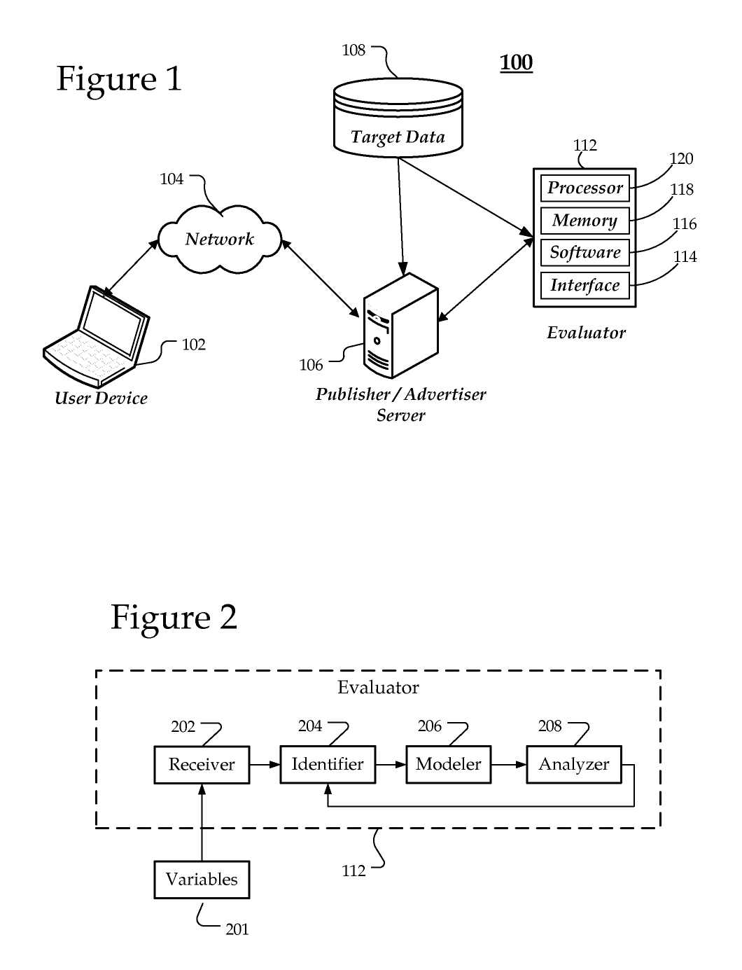

FIG. 1 depicts a block diagram illustrating one embodiment of an exemplary network system 100. The network system 100 may provide a platform for the analysis of target data for providing targeted advertisements (“ads”). In the network system 100, a user device 102 is coupled with a publisher/advertisement (“ad”) server 106 through a network 104. An evaluator 112 may be coupled with the publisher/ad server 106. Target data 108 may be from a third party data provider and is provided to the publisher/ad server 106 and used by the evaluator 112. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to a network 104, such as the Internet. Examples of a user device include, but are not limited to, a personal computer, personal digital assistant (“PDA”), cellular phone, or other electronic device. The user device 102 may be configured to allow a user to interact with the web server 106, the publisher/ad server 106, or other components of the network system 100. The user device 102 may include a keyboard, keypad or a cursor control device, such as a mouse, or a joystick, touch screen display, remote control or any other device operative to allow a user to interact with content provided by the publisher/ad server 106 via the user device 102. In one embodiment, the user device 102 is configured to request and receive information from the publisher/ad server 106. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla). The data displayed by the browser may include advertisements. In an alternative embodiment, software programs other than web browsers may also display advertisements received over the network 104 or from a different source.

The publisher/ad server 106 may act as an interface through the network 104 for providing a web page to the user device 102. In one embodiment, there may be a separate publisher server and advertisement server, where the publisher server is operated by the publisher server and the advertisement server provides advertisements from an advertiser. In another embodiment, there may be a separate web server that acts as the interface with the user device 102 that connects with the publisher/ad server 106. As described below, the publisher/ad server 106 will be described as providing content to the user device 102 even though there may be additional intermediary components (e.g. a web server) that provide the content on behalf of the publisher and/or advertiser for the publisher/ad server 106.

The pages that are provided to the user device 102 from the publisher/ad server 106 (or web server) may include advertisements. In one embodiment, the publisher/ad server 106 may include or be coupled with a search engine, and the provided page may be a search results page that includes advertisements. In one example, a web server may receive requests from the user device 102 and route data from the search engine and/or the publisher/ad server 106 for display back on the user device 102.

In one embodiment, there may be web database in the network system 100 that stores information about the pages and/or content that are provided to the user device 102. For example, an exemplary database may include records or logs of at least a subset of the requests for data/pages submitted over the network 104. In one example, the database may include a history of Internet browsing data related to the pages provided. The stored data may relate to or include various user information, such as preferences, interests, profile information or browsing tendencies, and may include the number of impressions and/or number of clicks on particular advertisements. The data may also include target data and/or variables as discussed below.

The publisher/ad server 106 may include a separate publisher server and a separate ad server. In one embodiment, the publisher server is a web server that provides content from the publisher, and the ad server provides advertisements from an advertiser that is included with the content from the publisher. In the embodiment described below, the publisher/ad server 106 provides content from a publisher and provide advertisements from an advertiser.

In its role as an ad server, the publisher/ad server 106 may provide advertisements with or as a part of the pages provided to the user device 102. Alternatively, the publisher/ad server 106 may provide advertisements to a web server that adds them to web pages that are provided to the user device 102. The publisher/ad server 106 may provide advertisements for display in web pages, such as the publisher's pages. The advertisements may relate to products and/or services for a particular advertiser. The advertiser may pay the publisher for advertising space on the publisher's page or pages.

In its role as a publisher server, the publisher/ad server 106 may provide pages (e.g. web pages) to the user device 102. The publisher/ad server 106 may be a web server that provides the user device 102 with pages (including advertisements) that are requested by a user of the user device 102. In one example, the publisher may be a news organization, such as CNN® that provides all the pages and sites associated with www.cnn.com. Accordingly, when the user device 102 requests a page from www.cnn.com, that page is provide over the network 104 by the publisher/ad server 106. As described below, that page may include advertising space or advertisement slots that are filled with advertisements viewed with the page on the user device 102. The publisher/ad server 106 may be operated by a publisher that maintains and oversees the operation of the publisher server 106.

The publisher may be any operator of a page displaying advertisements. The publisher may oversee the publisher/ad server 106 by receiving advertisements from an advertiser that are displayed in pages provided by the publisher/ad server 106. In one embodiment, an evaluator 112 may be used to analyze the effectiveness of advertisements based on targeting considerations. The evaluator 112 may be used to analyze and evaluate targeting data received from a third party data provider.

The target data 108 may be stored in a database be coupled with the publisher/ad server 106 and may store the pages or data that is provided by the publisher/ad server 106. The database may include records or logs of at least a subset of the requests for data/pages submitted to the publisher server/ad 106 over a period of time. In one example, the database may include a history of Internet browsing data related to the pages provided by the publisher/ad server 106. The data stored in the database may relate to or include various user information, such as preferences, interests, profile information or browsing tendencies, and may include the number of impressions and/or number of clicks on particular advertisements. The database may store advertisements from a number of advertisers, such as images, video, audio, text, banners, flash, animation, or other formats may be stored in the database. Alternatively, there may be a nother advertising database that stores advertisements and/or advertisement records. Advertisement records including the resulting impressions, clicks, and/or actions taken for those advertisements may also be stored. The stored data may include targeting data that the evaluator 112 uses for analyzing the effectiveness of an advertisement. The data may be continuously updated to reflect current viewing, clicking, and interaction with the advertisements displayed on the user device 102.

The advertisements, their usage data, as well as other tracking metrics, may be analyzed by the evaluator 112. The evaluator 112 may be coupled with the publisher/ad server 106 for assessing the effectiveness of the ads, which reflects the effectiveness of the targeting of those ads. In one embodiment, the evaluator 112 may be controlled by a publisher and/or an advertiser and may be a part of the publisher/ad server 106. Alternatively, the evaluator 112 may be a separate entity that analyzes the target data 108 as well as other tracking data from the publisher/ad server 106.

The evaluator 112 may be used by the publisher/ad server 106 for evaluating and analyzing targeting data that is used for targeting advertisements to a particular user and/or audience. As discussed, the evaluator 112 may develop a model that considers various independent and dependent variables that assesses any incremental value provided by additional targeting data. The evaluator 112 may be a computing device for evaluating and analyzing targeting data to determine the incremental value provided by the targeting data. The evaluator 112 may include a processor 120, a memory 118, software 116 and an interface 114. The evaluator 112 may be a separate component from the publisher/ad server 106, or it may be combined as a single component or hardware device.

The interface 114 may communicate with the user device 102 and/or the publisher/ad server 106. The interface 114 may include a user interface configured to allow a user and/or administrator to interact with any of the components of the evaluator 112. For example, the administrator and/or user may be able to review or update the variables in the evaluation model used by the evaluator 112.

The processor 120 in the evaluator 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The interface 114 may be a user input device or a display. The interface 114 may include a keyboard, keypad or a cursor control device, such as a mouse, or a joystick, touch screen display, remote control or any other device operative to allow a user or administrator to interact with the evaluator 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters. In particular, the interface 114 may allow a user to interact with the evaluator 112 to view or modify the variables and/or model used for evaluating targeting data.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a network, including but not limited to the network 104. For example, the evaluator 112 may be coupled with the publisher/ad server 106 through a network. Accordingly, any of the components in the system 100 may include communication ports configured to connect with a network.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. As discussed, the publisher/ad server 106 may provide advertisements and/or content to the user device 102 over a network, such as the network 104.

The evaluator 112, the publisher/ad server 106, and/or the user device 102 may represent computing devices of various kinds. Such computing devices may generally include any device that is configured to perform computation and that is capable of sending and receiving data communications by way of one or more wired and/or wireless communication interfaces, such as interface 114. For example, the user device 102 may be configured to execute a browser application that employs HTTP to request information, such as a web page, from the web server 106.

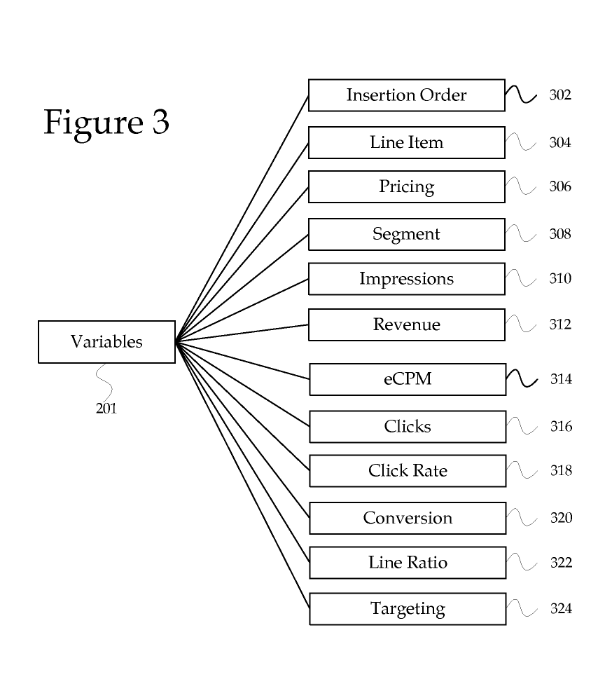

FIG. 2 illustrates an embodiment of the evaluator 112. The evaluator 112 may receive variables 201 at a receiver 202. The variables 201 are described below with respect to FIG. 3. In particular, the variables 201 may be independent variables or dependent variables. In one embodiment, the dependent variable is the item to be predicted and the independent variable may be used for predicting the dependent variables. The independent variables may be predetermined (before a user sees an advertisement) while the dependent variables are unknown and are estimated by the model. For example, the dependent variable may be an impact or influence of external targeting data from a third party. The impact may be a marginal impact as to whether a certain independent variable (e.g. targeting) impacts the output (e.g. probability of conversion change). This may be measured in percentage change or elasticity.

The dependent variables may include a determination as to whether a user clicks on an advertisement or makes a conversion. The generated model may determine an attribution of the dependent variable to a conversion. The independent variables may refer to data that is already known or data that is not modeled or predicted. For example, internal targeting data may be the independent variable(s), while external targeting data is the dependent variable. Variables may also be referred to as factors or considerations that impact the success of an advertisement. The success of an advertisement may include a conversion in one example. A probability of conversion may be a dependent variable that depends on a number of other variables. Examples of other variables include age and geographic location. Age and geographic location may be independent variables that are given and can impact the dependent variable, such as the probability of conversion.

FIG. 3 illustrates exemplary variables 201. The variables 201 illustrated in FIG. 3 are merely exemplary and there may be additional variables (independent or dependent) that are used for the evaluation described herein. The insertion order 302 is the order in which an advertiser inserts advertisements. In particular, an advertiser insertion order 302 may refer to which targeting data is initially used or may refer to which data takes precedence. For example, the external targeting data may be used after the internal targeting data is used, which impacts the potential significance of the external targeting data. In other words, the insertion order 302 is an indication of which data is considered.

A line item 304 refers to a group that is targeted. The line item may be a specific group that is identified as part of the targeting data. For example, a group may differentiate users based on demographics, job, income, browsing history, conversion history, or other details. The pricing 306 variable includes the price of an advertisement. One option is cost per mil (“CPM”) or dynamic CPM (“DCPM”). CPM refers to a cost per impression or a cost per interaction/conversion/action. For cost per impression, the cost may be based on 1000 impressions. DCPM refers to a dynamic pricing system in which the CPM changes by time, competition, or other factors.

Different users may be grouped into a segments 308 variable. A segment 308 is a targeted group of users or a targeted audience. A particular segment 308 may be targeted through different line items. As discussed, a line item is a group that is targeted with particular targeting data. In other words, a segment 308 is an identification of users and a line item identifies the users and the context or location in which they are being shown ads. A segment may be a group of users that have some common attribute that may impact the dependent variable (e.g. the probability of conversion). For example, a segment of users who have searched on a specific term, or a segment of all users who have visited a specific web site may be used as a common attribute.

Impressions 310 may refer to the number of times that an advertisement is seen or displayed to a user. In one embodiment, impressions 310 be used as part of the pricing 306, where the advertiser pays for its advertisement based on the number of impressions 310. Revenue 312 may refer to the income from the advertisement or campaign. eCPM 314 is a variation of CPM and is referred to as an effective cost per mil. Clicks 316 refer to the number of clicks of an advertisement. Alternatively, clicks 316 may refer to or include interactions and actions by the user with the advertisement. Click rate 318 is a percentage in which the advertisement is clicked based on how often the advertisement is displayed. In other words, click rate 318 may be the number of clicks divided by the number of impressions. The conversion 320 may refer to specific interactions after a click 316. For example, a conversion 320 may include a click on an advertisement followed by a purchase of the advertised product. In other words, the purchase of the product may be referred to as a conversion. A conversion may also include putting an item into a cart, or interacting with a page.

A line ratio 322 is the segment interaction of the line item. It may refer to an overlap or correlation between users within a line item. In other words, the targeting of working mothers in one context may include working mothers from a different context and those users from the different context are the line ratio 322. The line ratio 322 may be a percentage of users in the different context. Targeting 324 is an identification of a line. In other words, targeting 324 is the identification of which users to target and in what context those users are targeted.

Referring back to FIG. 2, the receiver 202 receives data, including the variables 201 that are provided to an identifier 204. The identifier 204 identifies at least one of the variables 201 as the dependent variable(s) for evaluation. The dependent variable is the variable of interest that is to be determined. For example, the dependent variable may be the probability that a user buys a product. The identifier 204 may identify one dependent variable or may identify multiple dependent variables. In one embodiment, multiple dependent variables may be evaluated individually. Alternatively, the multiple dependent variables may be evaluated concurrently.

The modeler 206 develops a model of the interaction between dependent and independent variables. In one embodiment, the model is developed before the dependent variable is identified. Alternatively, a model is developed based on the identified dependent variable. An analyzer 208 may analyze the results from the modeler 206 and update the model based on the results. The analysis may include determining which targeting data 108 influenced the dependent variable. In one embodiment, the modeler 206 and the analyzer 208 may be combined into a single component that generates the model and uses the model with the dependent variable to analyze which targeting data affects the dependent variable.

In one embodiment, the analysis of conversions from a number of impressions may be modeled using a Generalized Linear Model (“GLM”) or another regression model. The GLM will be described below, however, other regression models may also be used. In the case of the GLM, the probability of conversion is modeled as a function of explanatory or independent variables. An explanatory variable may be an independent variable that may explain why a person is say more likely to purchase in one example. In one example, the model is a function for determining a probability of a conversion rate that includes internal behavioral or targeting data and external behavioral or targeting data. The external targeting data may also be referred to as third party data and may include the targeting data 108 shown in FIG. 1. Alternatively, the targeting data 108 may include both internal and external targeting data. The internal targeting data may include behavioral or demographic data that is known by the publisher and/or advertiser and used for targeting advertisements. In one embodiment, the publisher and/or advertiser may purchase or receive external targeting data from a third party provider. The model is used to evaluate the contribution that the external or internal targeting data made to any conversions or other action (e.g. impression, click, purchase, etc.). In alternative embodiments, the model may include only internal or only external targeting data and the results of the model reflect which of that data is most effective.

The GLM may be a function of explanatory variables xₑ and xᵢ is f(T₀+xₑTₑ+xᵢTᵢ) where T₀ is the base conversion rate and Tₑ corresponds to the weight or impact of external targeting data on a conversion and Tᵢ corresponds to the weight or impact of external targeting data on a conversion. The model determines the weight or impact of external targeting data Tₑ in at least two ways. First, when Tₑ is significantly different from zero, then the external targeting data contributed to a conversion. Second, a large positive value of Tₑ may indicate a significant and positive contribution of the external targeting data to conversions, while a large negative value of Tₑ may indicate a significant and negative contribution of the external targeting data to conversions. The value of Tₑ may be used to determine a value of the external targeting data. For example, when a third party sells targeting data, the price may be based only on conversions, but the conversions may be attributed to internal and/or external targeting data, so the values of Tₑ and Tᵢ provide a measure for attributing conversions to the source of targeting data. In alternative embodiments, the analysis may be used for analyzing only internal targeting data to assign value to certain internal data and determine which data is most effective.

One embodiment of a generalized linear model (GLM) for binomial data that models the conversion rate θ as

$$θ = \frac{{e}^{{β}_{0} + {β}_{IO} IO + {β}_{BK} BK + {β}_{BT} BT}}{1 + {e}^{{β}_{0} + {β}_{IO} IO + {β}_{BK} BK + {β}_{BT} BT}}$$

The model may identify the values of β=[β₀, β_{IO}, β_{BK}β_{BT}]. BK may be an example of third party data and BT may be an example of local or first party data. Both BK and BT are independent variables that affect the dependent variable of conversion rate θ. β₀ may correspond to the base conversion rate, β_{BK} corresponds to the weight or impact of the third party data on the conversion, and β_{BT} corresponds to the weight or impact of the local or first party data on the conversion. The impact of third party data can be determined by identifying β_{BK} and determining whether it is significantly different from zero and whether the contribution is positive or negative. The model can be modified to use the log of third party data. The model may be analyzed for its fit to the data using “AIC” or “Residual Deviance” in two examples. The deviance may determine what the model fails to account for. If the model were perfect, it would predict exactly what happened. In this example, the prediction is the probability of conversion that depends on a certain factors. The deviance analyzes the accuracy of the model in predicting whether a certain person will make a purchase. For example, based on a person's age, previous purchase history and geographic location, the model may determine that person will purchase. However, the output or prediction of the model may deviate from the actual observation. This deviation may be called the deviance or residual deviance. The smaller the deviance, the better the model.

In alternative embodiments, any of the receiver 202, the identifier 204, the modeler 206, and the analyzer 208 may be combined into a single component that performs multiple functions.

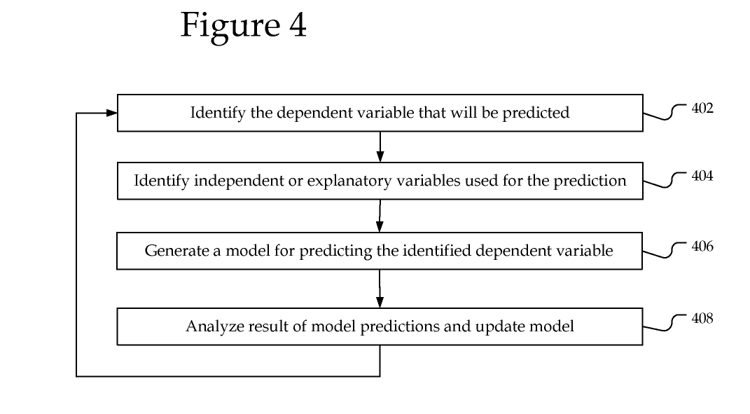

FIG. 4 illustrates an exemplary flowchart for evaluation. In block 402, the dependent variable is identified. For example, the identifier 204 may select the dependent variable that is subject to prediction by the model. In block 404, the independent variables or explanatory variables are identified. The independent variables or explanatory variables may be used by the model for predicting the behavior from the dependent variable. Any of the independent variables or explanatory variables or dependent variable may be any of the variables 201 illustrated in FIG. 3. In block 406, a model is generated that predicts the identified dependent variable. For example, the modeler 206 may generate the model based on the identified variables. The model may then be used for predicting an impact of the dependent variable in block 408. The analyzer 208 may analyze results of the model after inputs from the identified variables. The model may be updated based on the analysis of the results. When the model has been updated based on the results, the process in FIG. 4 may be repeated with the updated model. Alternatively, the identified variables in steps 402, 404, may be used and steps 406 and 408 are repeated with the updated model.

The system and process described may be encoded in a signal bearing medium, a computer readable medium such as a memory, programmed within a device such as one or more integrated circuits, and one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for analyzing targeting data comprising:
receiving the targeting data;
identifying a variable to analyze, wherein the variable to analyze indicates one or more events;
identifying one or more independent variables that impact the presence of the one or more events;
generating a model for analyzing the targeting data that includes the variable to analyze and the independent variables as inputs to the generated model; and
analyzing the generated model to determine an effect of the targeting data on the variable to analyze.

2. The method according to claim 1 wherein the one or more events comprises an indication of effectiveness of the targeting data.

3. The method according to claim 1 wherein the event comprises a click or a conversion.

4. The method according to claim 3 wherein the conversion comprises a purchase or a registration.

5. The method according to claim 1 wherein the targeting data is provided by a third party.

6. The method according to claim 5 further comprising:
determining a compensation for the third party, wherein the compensation is based on the effect of the targeting data on the variable to analyze, such that a greater effect results in more compensation.

7. The method according to claim 1 wherein the independent variables comprise at least one of insertion order, pricing, segment, impressions, revenue, line ratio, or targeting.

8. The method according to claim 1 wherein the model is a linear regression model.

9. The method according to claim 8 further comprising:
updating the generated linear model based on the determined effect from the targeting data; and
repeating the analysis using the updated model.

10. The method according to claim 1 wherein the determined effect comprises a marginal impact on the variable to analyze from the targeting data.

11. The method according to claim 10 wherein the variable to analyze comprises conversions and the percentage of impact comprises a percentage by which the conversions are caused from the targeting data.

12. A computer system for evaluating targeting data comprising :
a server configured to provide targeted advertisements and measure results from the provided targeted advertisements; and
an evaluator coupled with the server that comprises:
a receiver that receives targeting data;
an identifier that identifies a dependent variable to analyze and one or more independent variables that impact the effectiveness of the targeting data;
a modeler that develops a model for an interaction between the dependent variable and the independent variables; and
an analyzer that uses the model to determine whether the targeting data influenced the dependent variable.

13. The system of claim 12 wherein the dependent variable comprises conversions.

14. The system of claim 12 wherein the independent variables comprise at least one of insertion order, pricing, segment, impressions, revenue, clicks, conversion, line ratio, or targeting.

15. The system of claim 12 wherein the server provides web pages from a publisher, wherein the provided web pages include the targeted advertisements.

16. The system of claim 15 wherein the independent variables are measured by the publisher and the targeting data is provided by a third party.

17. The system of claim 16 wherein a compensation to the third party for receipt of the targeting data is determined by the influence on the dependent variable by the targeting data.

18. The system of claim 15 wherein the targeted advertisements are provided to the publisher from an advertiser.

19. In a computer readable medium having stored therein data representing instructions executable by a programmed processor for analyzing targeting, the storage medium comprising instructions operative for:
receiving internal targeting data and external targeting data;
identifying at least one variable that is impacted by the internal or external targeting data;
generating a linear model for analyzing an impact of the internal targeting data and the external targeting data on a conversion rate; and
attributing, with the linear model, a contribution from each of internal targeting data and external targeting data to the conversion rate.

20. The computer readable medium of claim 19 wherein the external targeting data is provided by a third party.

21. The computer readable medium of claim 20 further comprising:
determining a compensation for the third party, wherein the compensation is based on the contribution from the external targeting data to the conversion rate.

22. The computer readable medium of claim 19 wherein the linear model comprises a regression model.
